(19) United States
(12) Patent Application Publication
(10) Pub. No.: US 2012/0143844 A1
(43) Pub. Date: Jun. 7, 2012

(54) MULTI-LEVEL COVERAGE FOR CRAWLING SELECTION

(75) Inventors: Taifeng Wang, Beijing (CN); Tie-Yan Liu, Beijing (CN); Bin Gao, Beijing (CN)

(73) Assignee: Microsoft Corporation, Redmond, WA (US)

(21) Appl. No.: 12/958,611

(22) Filed: Dec. 2, 2010

(51) Int. Cl. G06F 17/30

(52) U.S. Cl. 707/709; 707/E17.108

(57) ABSTRACT

Some implementations provide techniques for determining which URLs to select for crawling from a pool of URLs. For example, the selection of URLs for crawling may be made based on maintaining a high coverage of the known URLs and/or high discoverability of the World Wide Web. Some implementations provide a multi-level coverage strategy for crawling selection. Further, some implementations provide techniques for discovering unseen URLs.

### BACKGROUND

A web crawler automatically visits web pages to create an index of web pages available on the World Wide Web (the Web). For example, a crawler may start with an initial set of web pages having known URLs. The crawler extracts any new URLs (e.g., hyperlinks) in the initial set of web pages, and adds the new URLs to a list of URLs to be scanned. As the crawler retrieves the new URLs from the list, and scans the web pages corresponding to the new URLs, more URLs are added to the list. Thus, the crawler is able to traverse a set of linked URLs to extract information from the corresponding web pages for generating a searchable index of the web pages.

The Web has become very large and is estimated to contain over one trillion unique URLs. Additionally, crawling is a resource-intensive operation. Given the current size of the Web, even large search engines are able to cover only a small portion of the estimated number of actual URLs on the Web. Therefore, search engines typically use algorithms to select particular URLs to crawl from among a large number of candidate URLs. However, the Web is constantly changing, with new URLs being added, and other URLs being updated or deleted. Additionally, not all URLs on the Web are linked to by other URLs, which makes it difficult for a crawler to locate these URLs.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide techniques for determining which URLs in a set of seen URLs to select for crawling. These implementations may handle selection of the seen URLs in different ways according to the URLs' categories. For example, some implementations maintain a high coverage and/or discoverability of the World Wide Web based on the selection techniques provided herein. Some implementations are based on directed optimization on seen hyperlink graphs. Some implementations are based on data mining to detect URLs with high discoverability on unseen URLs. Accordingly, URLs in different categories may be covered by different selection techniques, thereby providing a multi-level coverage strategy in crawling selection.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example of URL categorization for crawling selection according to some implementations.

FIG. 2 is a block diagram of an example framework for crawling selection according to some implementations.

FIG. 3 illustrates an example of generating a URL graph and corresponding adjacency matrix according to some implementations.

FIG. 4 is a flow diagram of an example process of crawling selection for optimized coverage according to some implementations.

FIG. 5 illustrates an example of mining and linking seen-but-not-linked URLs according to some implementations.

FIG. 6 is a flow diagram of an example process for mining and linking seen-but-not-linked URLs according to some implementations.

FIG. 7 is a flow diagram of an example of a learning process for selection of URLs with high discoverability according to some implementations.

FIG. 8 illustrates an example of comparing web snapshots for URL selection according to some implementations.

FIG. 9 is a flow diagram of an example process for comparing web snapshots for URL selection according to some implementations.

FIG. 10 is a block diagram of an example system architecture according to some implementations.

FIG. 11 is a block diagram of an example computing device and environment according to some implementations.

### DETAILED DESCRIPTION

### Multi-Level Coverage for Crawling Selection

The technologies described herein generally relate to selecting URLs for crawling. Some implementations provide a multi-level coverage strategy, which targets different areas in the Web based on a current observed status. For example, with respect to seen or known URLs, some implementations apply an optimization technique for selecting a subset of the seen URLs for crawling. Further, with respect to unseen or unknown URLs, some implementations apply a learning process for discovering and crawling unseen URLs. Thus, implementations herein may employ a multi-level coverage strategy for including both seen URLs and unseen URLs in crawling selection for index coverage.

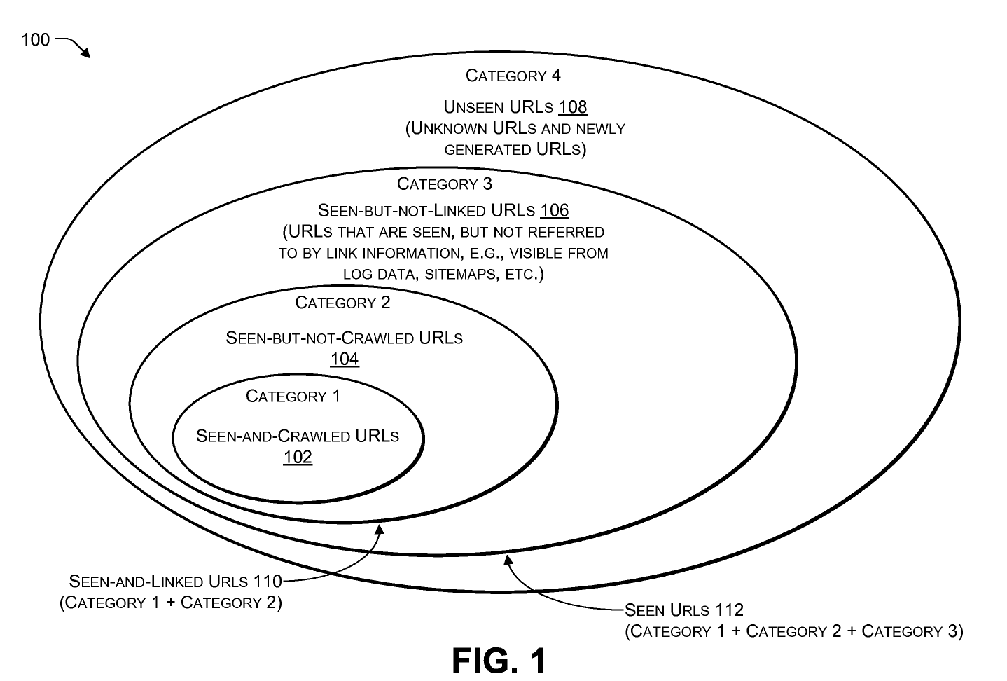

As illustrated in FIG. 1, some implementations herein employ a multi-level web categorization 100 for categorizing seen URLs and unseen URLs. In the illustrated example, URLs on the Web may be categorized into one of four possible categories (from core to frontiers), referred to as categories 1-4. Category 1 includes seen-and-crawled URLs 102; Category 2 includes seen-but-not-crawled URLs 104; Category 3 includes seen-but-not-linked URLs 106; and Category 4 includes unseen URLs 108. Each of these categories and URL types is discussed further below.

Category 1, the first category of URLs, may include current crawled and indexed web pages, referred to hereafter as seen-and-crawled URLs 102. Thus, each URL in this category has been crawled to identify any other URLs to which it may contain links. Further, the content of each seen-and-crawled URL 102 is typically indexed based on the crawling. Major search engines are currently estimated to encompass about 20-25 billion seen-and-crawled URLs 102.

Category 2, the second category of URLs, may include seen URLs that are known from links from the crawled web pages in the first category. These URLs may be referred to hereafter as seen-but-not-crawled URLs 104. Thus, these are URLs that are linked from the seen-and-crawled URLs 102, but have not actually been crawled themselves for various reasons, such as due to lack of time, lack of crawling resources, suspected redundancy, uncrawlable file type, or the like. Because the seen-but-not-crawled URLs 104 have not been crawled, some URLs that they link to may be unseen URLs 108 or seen-but-not-linked URLs 106 There currently may be an estimated 75-80 billion URLs in this category.

Furthermore, the seen-and-crawled URLs 102 of category 1 and the seen-but-not-crawled URLs 104 of category 2 may be collectively referred to as seen-and-linked URLs 110. For instance, these URLs are seen (i.e., known) and the link relationship between the URLs is also known.

Category 3, the third category of URLs, may include seen URLs that are not linked from other pages, but that instead have been discovered by other methods, such as from mining browser toolbar logs of users, mining website sitemaps, and the like. These URLs are referred to hereafter as seen-but-not-linked URLs 106. For example, users of a web browser may consent to having their browsing history data provided anonymously (or not) to a search engine provider. Thus, the browser logs of a large number of users may be provided from a browser toolbar to the search engine provider. This browsing history (hereafter URL log data) may be mined by the search engine provider to locate seen-but-not-linked URLs 106. For instance, sometimes a user may visit an unseen URL 108 from a seen-but-not-crawled URL 104. Alternatively, a user may type a URL directly into a toolbar to access the URL, rather than accessing the URL through a search engine or through a link from another URL. Thus, through mining of this log data in comparison with the seen-and-linked URLs 110 of categories 1 and 2, implementations herein may identify additional URLs that become seen but not linked. Thus, these URLs are known, but their link relationship remains unknown.

Further, inclusion in category 3 does not necessarily mean that the seen-but-not-linked URLs 106 are not linked to by any other URLs, but instead simply indicates that the seen-but-not-linked URLs 106 are not linked to by the seen-and-crawled URLs 102, and thus do not fall within category 1 or 2. For example, some of the seen-but-not linked URLs 106 may be linked to by the seen-but-not-crawled URLs 104, but because the seen-but-not-crawled URLs 104 have not been crawled, this information is not known. Additionally, a seen-but-not-linked URL 106 may actually be linked to a seen-and-crawled URL 102, but the link may have been formed after the seen-and-crawled URL 102 was last crawled, and so the link remains unknown. Furthermore, the seen-and-crawled URLs 102 of category 1, the seen-but-not-crawled URLs 104 of category 2, and the seen-but-not-linked URLs 106 of category 3 may be collectively referred to as seen URLs 112. For instance, these URLs are seen (i.e., known) even though the link relationships of some of URLs may not be known.

Category 4, the fourth category of URLs, are unknown URLs, which may include newly generated URLs, and are referred to hereafter as unseen URLs 108. As mentioned above, search engines are unable to see or provide indexing of all of the URLs on the Web. This is partially due to the large number of URLs and the fact that millions of new or altered pages are added to the Web every day. For example, some unseen URLs 108 may be linked to by the seen URLs of categories 2-3, but because the URLs of categories 2-3 have not been crawled, the URLs remain unseen. Further, unseen URLs 108 may be linked to by the URLs of category 1, but the link may have been added after the URL was crawled. Furthermore, unseen URLs 108 may include disconnected pages that have no links from other pages that the crawler can use to find the disconnected page. Unseen URLs 108 may also include pages to which crawlers cannot gain access because interaction with a gateway and/or user authorization is necessary to gain access. Such URLs may include websites that provide access to databases, as well as social networking websites, online dating websites, adult content websites, and the like. Additionally, some unseen URLs refer to pages that are made up of file types that crawlers are unable to access or that crawlers are programmed to ignore. As mentioned above, the unseen URLs 108 of category 4 and the seen URLs 112 of categories 1-3 are estimated to total over one trillion URLs. As described below, various techniques are provided herein for discovering the unseen URLs 108.

Some implementations herein apply an optimized coverage selection strategy to the seen URLs 112 in categories 1-3 to select, for crawling, a subset from the entire set of seen URLs 112. The subset is selected using an optimization technique so as to maintain high coverage on both the current seen URLs 112 and also maintain high discoverability of the entire World Wide Web. Additionally, with respect to the unseen URLs 108, some implementations herein apply a learning technique and a relatively small amount of resources to discover unseen URLs, which then become seen URLs. Further, some implementations identify newly discovered URLs which can be used as bridge pages to discover additional unseen URLs. Consequently, some implementations herein include the following aspects for URL selection: (a) coverage of current seen URLs having known link information (i.e., seen-and-crawled URLs 102 and seen-but-not-crawled URLs 104); (b) coverage of current seen URLs without link information (i.e., seen-but-not-linked URLs 106); and (c) coverage of unseen URLs 108.

### Example Framework

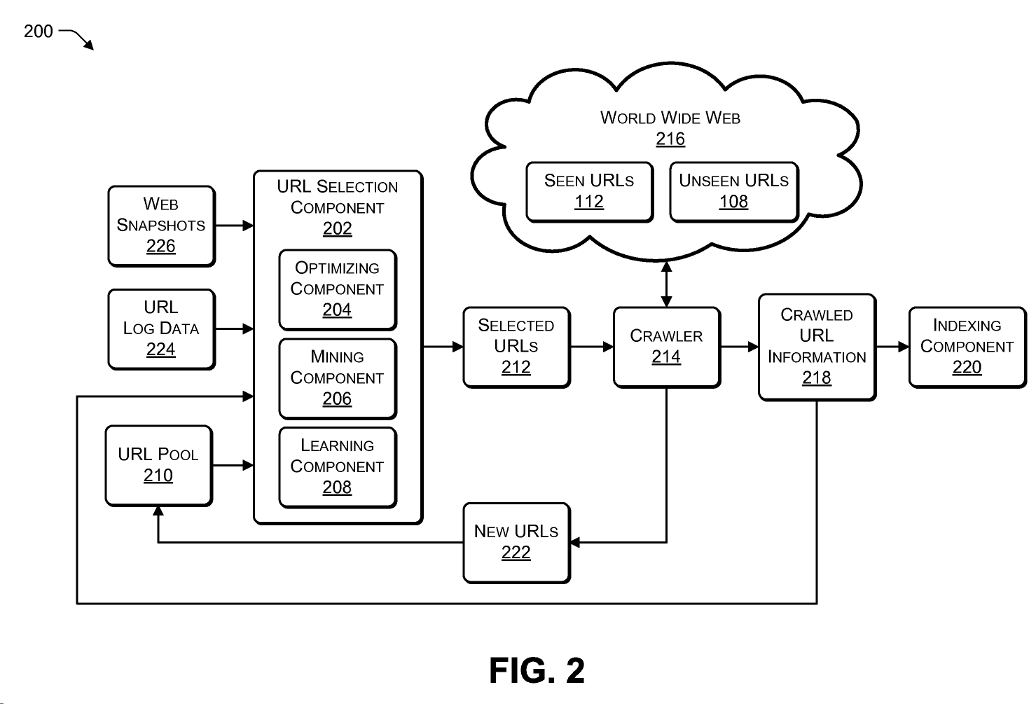

FIG. 2 is a block diagram of an example framework 200 for multi-level coverage for URL selection according to some implementations. Framework 200 includes a URL selection component 202 having an optimizing component 204, a mining component 206, and a learning component 208, the function of each of which is described additionally below. In some implementations, URL selection component 202 accesses a URL pool 210 that contains the seen URLs 112 that are currently known, such as the seen-and-crawled URLs 102, the seen-but-not-crawled URLs 104, the seen-but-not-linked URLs 106, and any unseen URLs 108 that subsequently become seen. For example, the URL selection component 202 may use the selection techniques described herein for determining a subset of URLs from the URL pool 210 to select for crawling.

The URL selection component 202 provides selected URLs 212 to a crawler 214 that crawls the selected URLs 212 by accessing the World Wide Web 216. As mentioned above, the Web 216 includes both the seen URLs 112 and the unseen URLs 108. As a result of the crawling the selected URLs 212, the crawler 214 provides crawled URL information 218 to an indexing component 220 for use in indexing the crawled URLs 212. Further, the crawled URL information 218 may also be provided to the URL selection component 202 for use by learning component 208 in selecting subsequent selected URLs 212 for crawling, as described additionally below.

As a result of crawling the selected URLs 212, the crawler 214 may locate new URLs 222 that were previously part of the unseen URLs 108. The new URLs 222 may be added to the URL pool 210, so that the new URLs 222 are considered in the selection process when selecting the selected URLs 212 for a next round of crawling. The URL selection component 202 may also receive URL log data 224 for use by mining component 206 for identifying seen-but-not linked URLs 106, and for establishing link relationships for the seen-but-not-linked URLs 106. Further, the mining component 206 may utilize web snapshots 226 for use in locating unseen URLs 108 to be added to the URL pool 210.

Selecting URLs from Categories 1 and 2 for Optimal Coverage

According to some implementations, optimizing component 204 may be executed to select, for crawling, optimal selected URLs 212 from the seen-and-crawled URLs 102 and the seen-but-not-crawled URLs 104, i.e., the current seen-and-linked URLs 110. The selected URLs 212 that are chosen by the optimizing component 204 are selected using an optimization technique so as to maintain high coverage on the current seen-and-linked URLs 110 and high discoverability of the entire Web. This is referred to hereafter as “optimal coverage.” Thus, implementations herein are able to maintain coverage of the current seen-and-linked URLs 110 while also providing high discoverability of the Web for new unique URLs. As used herein, selecting URLs for “high discoverability” of the Web means selecting URLs so that there is a high likelihood that new or unseen URLs will be discovered by crawling the selected URLs. Implementations herein address the URL selection problem as a constrained optimization problem in which the constraint is the number of selected source URLs (URLs selected for crawling). By crawling a minimal number of source URLs, the remaining URLs in the seen-and-linked URLs are seen to as large an extent as possible (e.g., links are discovered). Or, in other words, the selection of URLs for crawling is optimized to attempt to cover as many of the seen-and-linked URLs as possible when crawling a given number of source URLs (URLs selected for crawling).

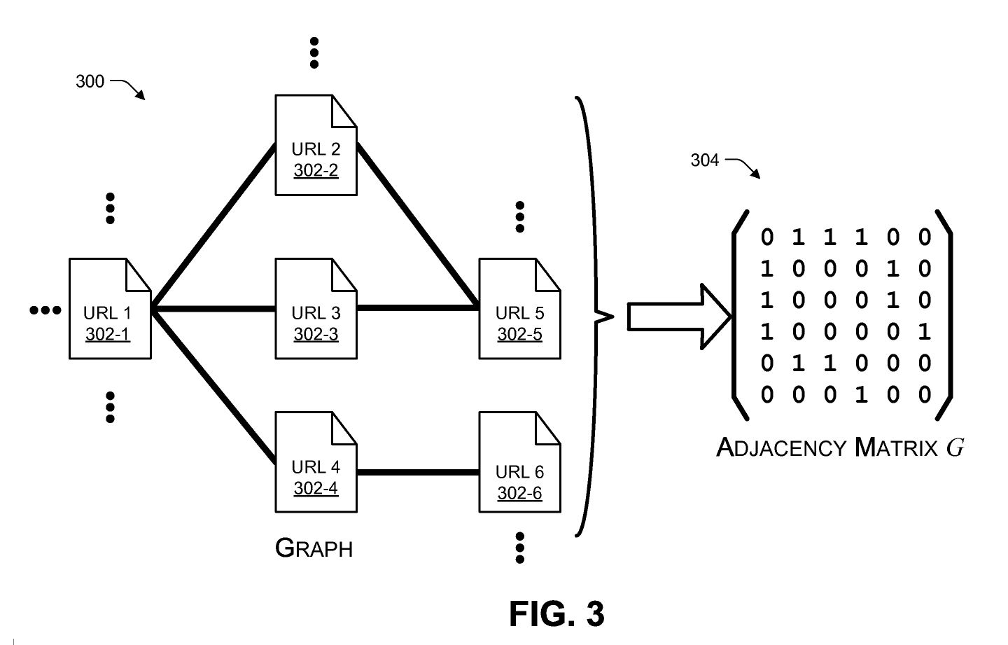

FIG. 3 illustrates an example of a graph 300 generated based on the link relationships between the seen-and-linked URLs 110 according to some implementations. For example, the seen-and-linked URLs 110 may be modeled as a graph data structure in which the URLs are the vertices of the graph and the links between the URLs are edges of the graph. Consequently, the seen-and-crawled URLs 102 and the seen-but-not-crawled URLs 104 may be represented as a very large graph data structure. Furthermore, from this graph, an adjacency matrix G may be generated for representing which vertices of a graph are adjacent to which other vertices, i.e., which URLs are linked to which other URLs. In the illustrated example of FIG. 3, URLs 1-6, 302-1, . . . , 302-6, respectively, are represented as a very small example portion of the graph 300 for discussion purposes. In the graph 300, URL 1 is linked to URL 2, URL 3, and URL 4; URL 2 is linked to URL 1 and URL 5; URL 3 is linked to URL 1 and URL 5; URL 4 is linked to URL 1 and URL 6; URL 5 is linked to URL 2 and URL 3; and URL 6 is linked to URL 4. These relationships between the URLs 1-6 may be represented as an adjacency matrix 304 in which the presence of a link is represented as a “1” and the lack of a link is represented as a “0”.

Implementations of the optimizing component 204 may apply the adjacency matrix in a URL selection technique based on the following Equation:

max(e^{T}Sgn(G^{T}W))

s.t.|W|=K (1)

where G is an adjacency matrix of at least some of the seen-and-linked URLs 110 and G^{T} is the transpose of the adjacency matrix G. In this equation, e^{T} represents a full one vector (i.e., a vector containing all ones), and W is a selection coefficient vector that has a value of either zero or one. Further, “Sgn(A)” means take the sign of each element in A and form a new matrix, and “s.t.” means select. By maximizing the product in Equation (1), implementations herein attempt to select those sources which can provide coverage for as many unique URLs in 110 as possible. In other words, G^{T} W gets a vector which indicates the number of time that each URL is seen (i.e., “seen times”) by the W selection, the Sgn function causes the element in the vector to become 1 (seen) or 0 (unseen). Further, from the left product e^{T}, a total number of seen URLs is provided. This number may be the optimization target, and the constraint is the number of source URLs selected.

Optimizing component 204 applies Equation (1) for selecting K source URLs from the seen-and-linked URLs 110 in the URL pool 210. The K source URLs are then provided to the crawler 214 as at least part of the selected URLs 212. By employing Equation (1), optimizing component 204 automatically selects those URLs in the adjacency matrix G that have the greatest number of links to other URLs and those URLs which will link to new unique URLs as well. This enables the optimizing component 204 to provide coverage of as many of the seen-and-linked URLs 110 as possible while performing a corresponding fewest number of URL crawls, thereby providing for an efficient utilization of crawling resources. For example, through use of the above technique, implementations herein are able to establish optimal coverage for the seen-and-crawled URLs 102, and also for the seen-but-not-crawled URLs 104 without actually crawling all of the seen-but-not-crawled URLs 104.

Furthermore, Equation (1) may be modified with other information used as weights or parameters to further influence which URLs are selected as the selected URLs 212. For example, additional constraints may be added to Equation (1) to ensure the selection of particular types of URLs, such as URLs corresponding to pages with high discoverability, white-listed URLs, idea set URLs, high page ranked URLs, etc. In addition, other constraints or weights may be added to avoid the selection of URLs corresponding to spam or junk pages. To ensure these additional constraints take effect in this selection model, some implementations may change the vector e^{T} to a weighted vector including the weighting parameters. Thus, the weighted vector may add weight to those URLs that are desired to be selected, and add smaller or negative weight to those URLs, such as spam URLs, whose selection is undesirable.

### Example Process

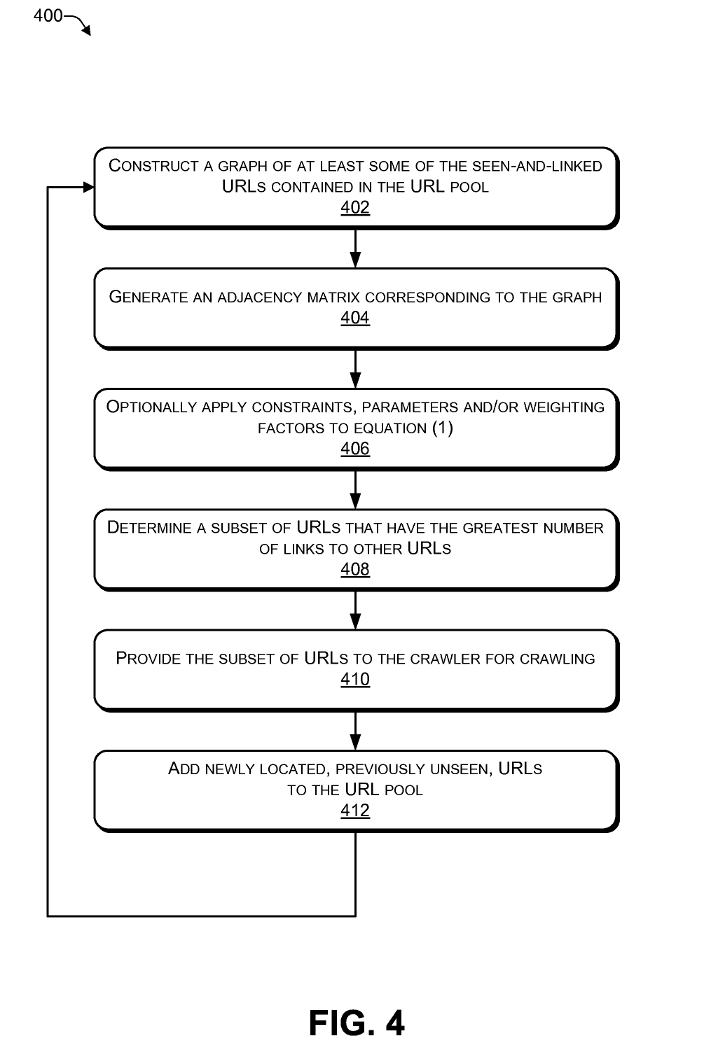

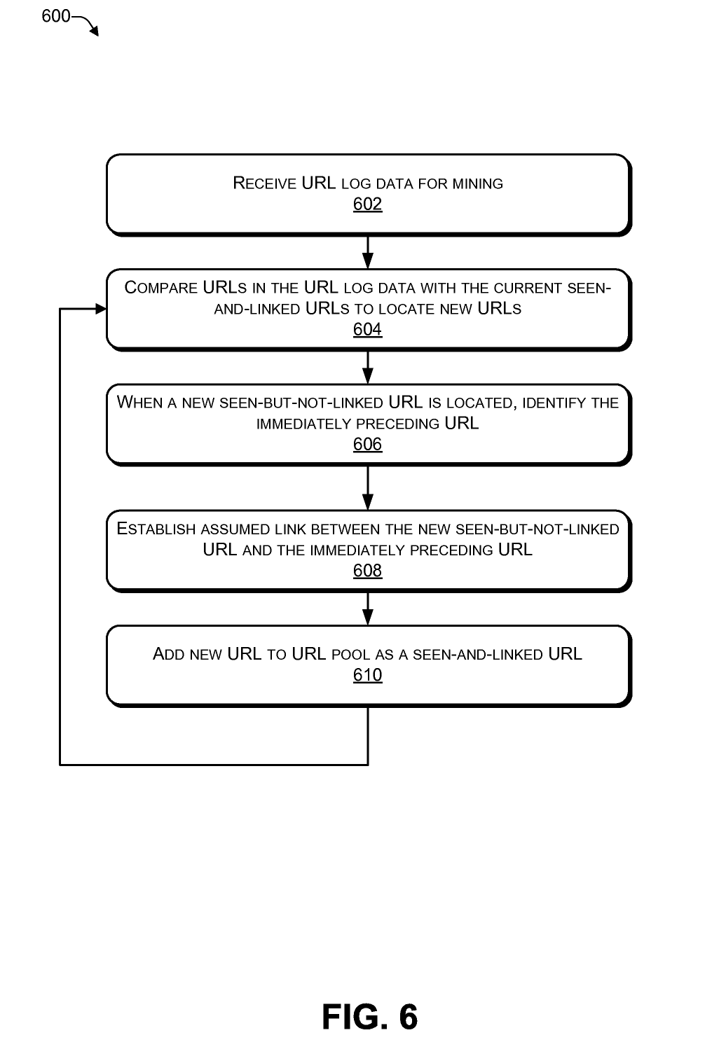

FIG. 4 is a flow diagram of an example process 400 for optimal selection of URLs for crawling according to some implementations herein. In the flow diagram of FIG. 4, and in the flow diagrams of FIGS. 6, 7 and 9, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, components, data structures, and the like that perform particular functions or implement particular abstract data types. The order in which the blocks are described is not intended to be construed as a limitation, and any number of the described operations can be combined in any order and/or in parallel to implement the process. For discussion purposes, the process 400 is described with reference to the framework 200 of FIG. 2, although other frameworks, devices, systems and environments may implement this process.

At block 402, a graph is constructed from at least some of the seen-and-linked URLs 110 in the URL pool 210. For example, the optimizing component 204 may construct a URL graph data structure of at least some of the known URLs that have link information associated therewith, e.g., the URLs 102 and 104 contained in categories 1 and 2, respectively, described above.

At block 404, the optimizing component 204 generates an adjacency matrix corresponding to the URL graph. For example, the adjacency matrix may be used to represent which vertices of the URL graph are adjacent to which other vertices, i.e., which URLs are linked to which other URLs.

At block 406, optionally, the optimizing component 204 may apply additional constraints, parameters, and/or weighting factors to Equation (1) to achieve particular selection results. The constraints, parameters or weighting factors may be applied to ensure the selection of particular types of URLs, such as URLs corresponding to pages with high discoverability, white-listed URLs, idea set URLs, high page ranked URLs, and/or to avoid spam pages.

At block 408, the optimizing component 204 determines a subset of URLs that have the greatest number of links to other URLs in the graph. For example, Equation (1) may be applied to determine, from the adjacency matrix, those URLs that will provide the greatest amount of coverage per expenditure of crawling resources. Consequently, implementations herein are able to establish optimal coverage for the seen-and-crawled URLs 102, and also for the seen-but-not-crawled URLs 104 without actually crawling all of the seen-but-not-crawled URLs 104. For example, the coverage of a URL is typically not known until the URL has been crawled, but using Equation (1), implementations herein are able select URLs having high coverage before crawling the URLs.

At block 410, the URL selection component 202 provides the selected subset of URLs to the crawler 214. The crawler receives the selected subset of URLs and accesses the Web to crawl the selected URLs.

At block 412, any previously unseen URLs that are newly located during the crawling of the selected URLs are added to the URL pool. The process may then return to block 402 to generate a new or modified URL graph that includes any new URLs that have been added to the URL pool.

Selecting URLs from Category 3

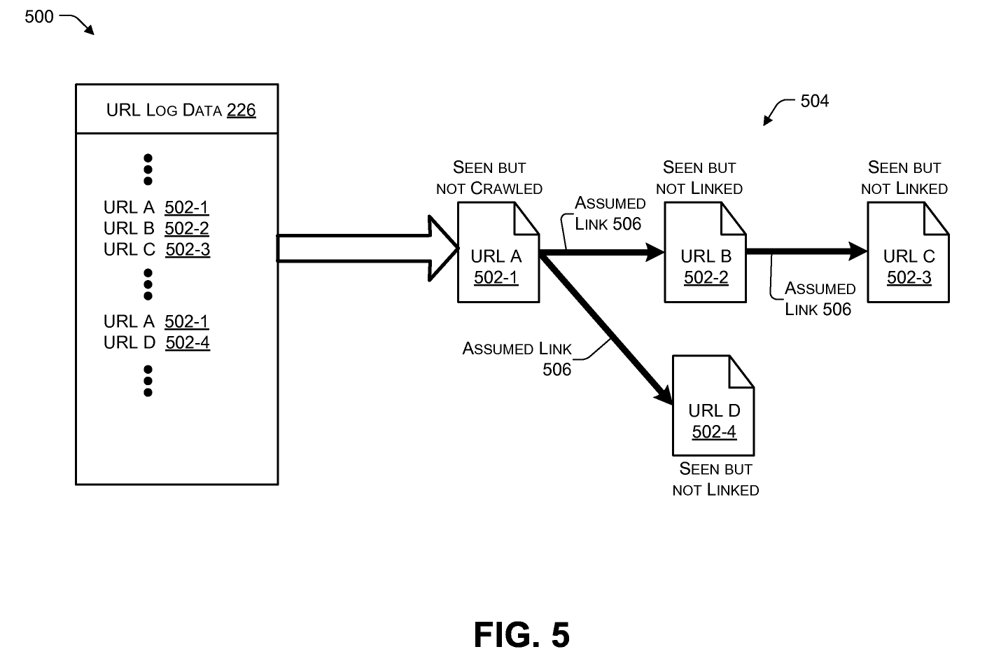

FIG. 5 illustrates an example of a technique 500 for enabling the seen-but-not-linked URLs 106 to be included in the optimal coverage selection technique described above with reference to FIGS. 3-4. For example, the seen-but-not-linked URLs 106 would not work properly in the optimal coverage selection technique because they are not linked to any other URLs, would have no link information in the web graph, and therefore would have zero value in the adjacency matrix G. In some implementations, the majority of the seen-but-not-linked URLs 106 come from toolbar logs or other URL log data 226. Implementations herein may employ the mining component 206, to mine URL information from user behavior data represented by the URL log data 226. Thus, according to some implementations, the mining component 206 may identify a particular URL in the URL log data 226 that immediately precedes a detected seen-but-not-linked URL 106. The technique 500 may assume that the seen-but-not-linked URL 106 is linked to the immediately preceding URL, and therefore establishes a link based on this assumption. This brings the seen-but-not-linked URL 106 out of category 3 and into category 2, so that the seen-but-not-linked URL 106 is now linked in the URL graph and may be included in the optimal coverage URL selection technique described above with respect to FIGS. 3-4 and Equation (1).

For example, as illustrated in FIG. 5, suppose that URL log data 226 shows that a user visited URL A 502-1, immediately followed by visits to URL B 502-2, and URL C 502-3. URL log data 226 also shows that a user visited URL A 502-1 followed immediately by a visit to URL D 502-4. Further, suppose that URL B, URL C, and URL D are seen-but-not-linked URLs 106. The mining component 206 may detect that URL A, a seen-and-linked URL 110, immediately precedes URL B and URL D in the log data 226. According to some implementations, a link graph 504 may be generated by detecting the immediately preceding URL, which is not a seen-but-not-linked URL 106. The mining component 206 may form assumed links 506 that link one or more seen-but-not-linked URLs 106 to the immediately preceding URL. Thus, in the illustrated example, URL B is linked to URL A and, because URL B immediately precedes URL C which is also a seen-but-not-linked URL 106, URL C is linked to URL B. Further, URL D is also linked to URL A. Based on the assumption that the URLs are linked to the immediately preceding URL in the log data 226, the seen-but-not-linked URLs 106 become linked and may be added to the graph data structure 300 described above. The optimal coverage selection technique described above may then be applied to these URLs as well, as part of the candidate URLs available for selection in the URL pool 210.

### Example Process for Seen-but-not-Linked URLs

FIG. 6 is a flow diagram of an example process 600 for mining and linking the seen-but-not-linked URLs 106 according to some implementations herein. For discussion purposes, the process 600 is described with reference to the framework 200 of FIG. 2, although other frameworks, devices, systems and environments may implement this process.

At block 602, the mining component 206 receives URL log data 224 for URL mining. For example, the URL log data may be received from various sources such as the browsing histories of a large number of anonymous users.

At block 604, the mining component 206 compares the URLs listed in the URL log data 224 with the current seen-and-linked URLs 110 to locate any new URLs. Any new URL that is located becomes a seen-but-not-linked URL 106. However, because there is no link information for the new seen-but-not-linked URL 106, the new seen-but-not-linked URL 106 would not be useful in the optimal coverage selection technique described above with reference to FIGS. 3-4.

At block 606, when a new seen-but-not-linked URL is located, the mining component 206 identifies the URL immediately preceding the new seen-but-not-linked URL.

At block 608, the mining component 206 establishes an assumed link between the new seen-but-not-linked URL and the immediately preceding URL. For example, the immediately preceding URL may be one of the seen-and-linked URLs 110. For example, in the case that the immediately preceding URL is a seen-but-not-crawled URL 104, because the seen-but-not-crawled URL 104 has not been crawled, its links are unknown, and it is very possible that seen-but-not-crawled URL 104 has a link to the new seen-but-not-linked URL. Furthermore, in the case that the immediately preceding URL is a seen-and-crawled URL 102, it is possible that the detected seen-but-not-linked URL 106 is a new link that has been formed since the last time that the seen-and-crawled URL 102 was crawled. Additionally, in the case that the immediately preceding URL is another seen-but-not-linked URL 106, then this immediately preceding URL will have already been linked to another URL that immediately preceded it, as in the case of URL B 502-2 and URL C 502-3 discussed above with reference to FIG. 5.

At block 610, the new URL is added to the URL pool as a seen-but-not-crawled URL 104, relying on the assumed link established with the immediately preceding URL. Consequently, the new URL may be included in the graph data structure 300 and encompassed by the optimized coverage selection technique discussed above.

### Coverage of Unseen URLs

Some implementations herein attempt to locate unseen URLs that have a high level of discoverability. As used herein, “discoverability” of a particular URL indicates how many new or unseen URLs can be discovered by crawling the particular URL. Thus, it is more efficient to locate and crawl unseen URLs 108 that have a high level of discoverability, because these URLs will lead to discovery of more URLs, thereby using a smaller amount crawling resources for locating unseen URLs. To carry out discovery and coverage of unseen URLs, implementations herein may apply a two-part approach that includes (1) sandbox or background crawling that uses feature-based learning to select URLs with a high level of discoverability; and (2) data mining of web snapshots to discover unseen URLs which can be used as bridges to discover yet more unseen URLs.

### Sandbox Crawling

According to some implementations of the sandbox crawling portion, in general the discoverability of a seen-but-not-crawled URL is unknown until the URL is actually crawled. However, implementations herein may reserve a small portion of crawling resources for background or “sandbox” crawling in which URLs are selected from the set of seen-but-not-crawled URLs 104 (category 2) for crawling to attempt to locate any unseen URLs that may be linked thereto. Further, rather than performing such crawling randomly, implementations herein employ a feature-based learning technique implemented by learning component 208 to select for sandbox crawling those URLs predicted to have a higher level of discoverability. For example, the learning component 208 may select a small set of seen-but-not-crawled URLs 104 to be crawled to attempt to locate unseen URLs for increasing indexing coverage.

Further, learning component 208 may select the set of URLs to be crawled based on particular features that have been learned to lead to higher levels of discoverability. For example, features such as URL length, URL domain name, URL type, ratio of words to numbers in the URL, special characters used in the URL, file type of the URL, and the like, may be used as features applied to a model by learning component 208 when crawling selected URLs. As more URLs are crawled, the learning component establishes optimal values or ranges for particular features for pages that were demonstrated to have a high level of discoverability. For example, the learning component 208 may receive crawled URL information 218 from the crawler 214 regarding the discoverability of each URL crawled. The learning component 208 may apply statistical and pattern identification analysis to learn optimal values or ranges of the various feature that are indicative of URLs having higher than average levels of discoverability. Based on the learned optimal values for the particular features, the learning component 208 is able to select for sandbox crawling those seen-but-not-crawled URLs 104 (including any seen-but-not-linked URLs 106) that have features corresponding to the optimal values of the particular features. Consequently, implementations herein are able to more effectively use the crawling resources allocated for discovering unseen URLs.

### Example Process for Discovering Unseen URLs

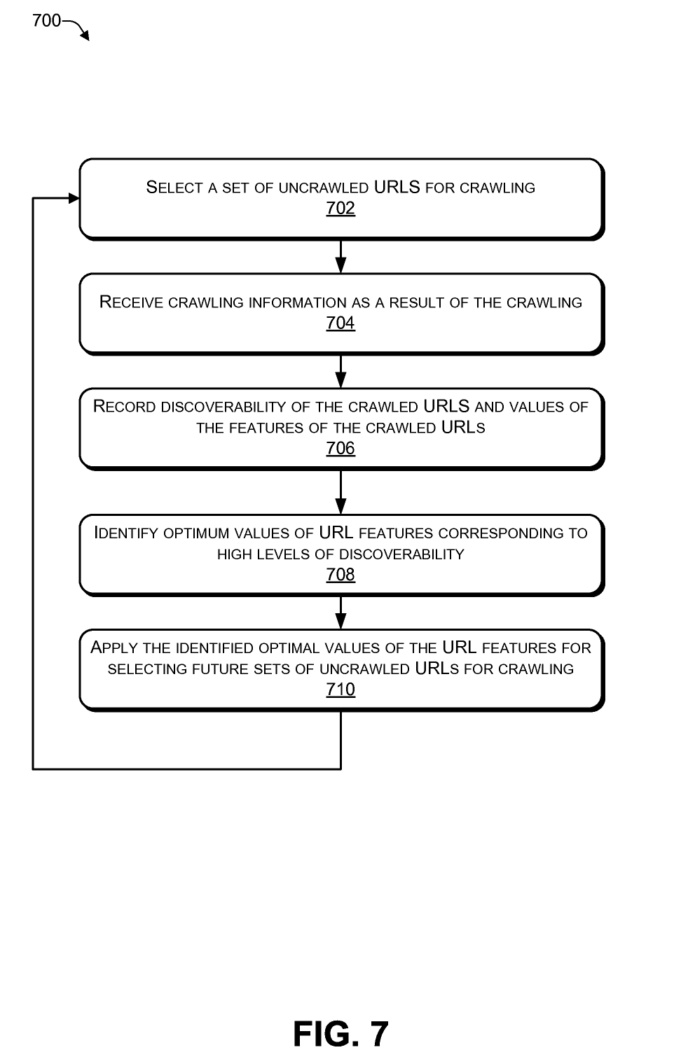

FIG. 7 is a flow diagram of an example process 700 for discovering unseen URLs according to some implementations herein. For discussion purposes, the process 700 is described with reference to the framework 200 of FIG. 2, although other frameworks, devices, systems and environments may implement this process.

At block 702, the learning component 208 selects a set of uncrawled URLs for crawling. For example, the learning component may select a small set of uncrawled URLs to attempt to locate unseen URLs for improving indexing coverage. The selected set of uncrawled URLs may be included with the selected URLs 212 selected by the optimizing component 204 as a small portion of the total selected URLs 212. Consequently, a portion of crawling resources are reserved for attempting to discover unseen URLs 108.

At block 704, the learning component 208 receives crawling information 218 obtained by the crawler 214 as a result of crawling the selected set of uncrawled URLs. For example, the crawling information 218 may indicate the discoverability of each URL of the selected set of uncrawled URLs. Further, the crawling information 218 may also be drawn from crawling other URLs.

At block 706, the learning component 208 records the discoverability of each of the URLs and further records values of the various features of the set of URLs. For example, the learning component may record values of features such as URL length, URL domain name, URL type, ratio of words to numbers in the URL, special characters used in the URL, file type of the URL, and the like.

At block 708, the learning component 208 may apply statistical analysis to the recorded discoverability and the corresponding recorded values for the features of the URLs in a pattern matching process to establish optimal ranges of values for one or more features that indicate a URL has a high probability of having a high level of discoverability.

At block 710, the learning component 208 applies the identified optimal URL features for selecting future sets of uncrawled URLs for crawling to attempt to identify uncrawled URLs have a high discoverability. Thus, the process returns to block 702 to apply the identified optimal values of the URL features during the selection process. Furthermore, as the process 700 is repeated, the accuracy of the optimal values established for the URL features may improve with each iteration.

### Data Mining of Web Snapshots

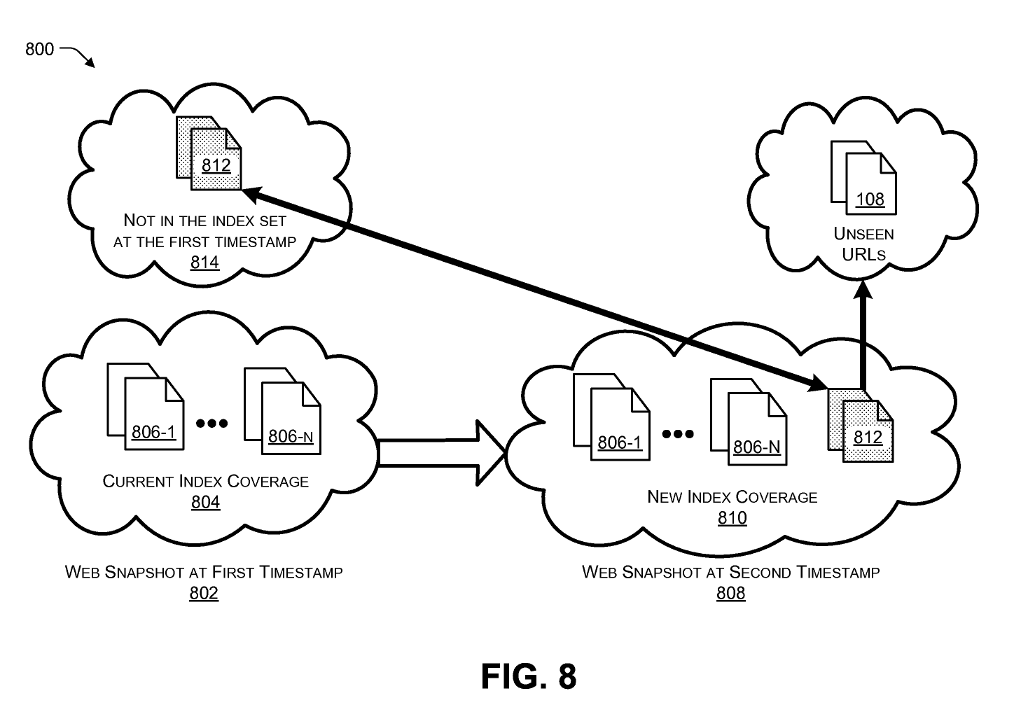

FIG. 8 illustrates a technique 800 for identifying unseen URLs based on data mining of web snapshots. As illustrated in FIG. 8, a first web snapshot at first timestamp 802 may show that an index coverage 804 at the first timestamp included URLs 806-1, . . . , 806-N. For example, the web snapshot at the first timestamp 802 may be the URL graph data structure 300 generated for the seen-and-linked URLs 110 discussed above with reference to FIGS. 3-4. Subsequently, a second web snapshot at a second timestamp 808 may be generated that includes new index coverage 810. New index coverage 810 may include the URLs 806-1, . . . , 806-N. Further, by comparison of the web graph of the first web snapshot at the first timestamp 802 with a second web graph of the second web snapshot at the second time stamp 808, newly-added URLs 812 may be identified as belonging to a group of URLs that were not in the index set at the first time stamp 814. Upon identification of these URLs 812, implementations herein may apply additional weighting parameters to the URLs 812 during execution of Equation (1) to greatly increase the likelihood of these URLs 812 being selected for crawling. Thus, these previously unseen URLs 812 may serve as bridge pages that are more likely to lead to other unseen URLs 108 than the general populace of candidate URLs in the URL pool 210. For example, these bridge pages 812 are treated as identified pages having a high level of discoverability. Consequently, the weighting factor may be applied to Equation (1) to increase the likelihood of these URLs being crawled. Further, in some implementations, these URLs 812 may also be submitted to the learning component 208 for assessing which of these URLs 812 might be most likely to have high discoverability based on the various features of the URLs 812.

### Example Process for Discovering Unseen URLs

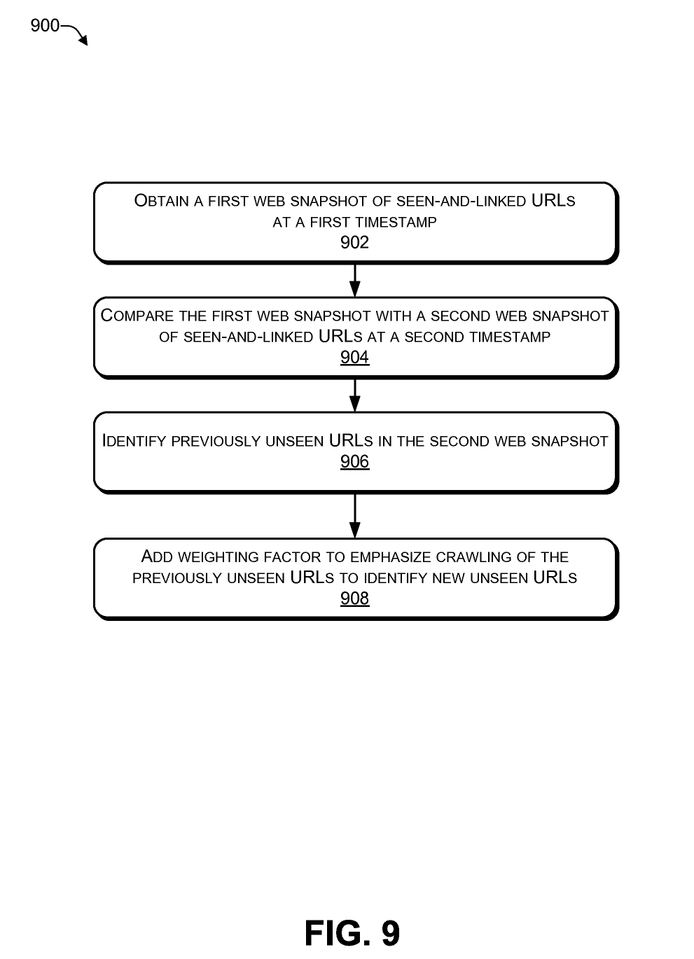

FIG. 9 is a flow diagram of an example process 900 for discovering unseen URLs based on comparison of multiple web snapshots according to some implementations herein. For discussion purposes, the process 900 is described with reference to the framework 200 of FIG. 2, although other frameworks, devices, systems, architectures and environments may implement this process.

At block 902, the mining component 206 obtains a first web snapshot of the seen-and-linked URLs 110 at a first timestamp. For example, the web snapshot may correspond to the graph data structure 300 generated for the seen-and-linked URLs 110 at a particular point in time, as discussed above with reference to FIGS. 3-4.

At block 904, the mining component 206 compares the first web snapshot with a second web snapshot of the seen-and-linked URLs taken at a second timestamp, subsequent to the first timestamp.

At block 906, the mining component 206 identifies previously unseen URLs that are in the second web snapshot that were not in the first web snapshot. Implementations herein may assume that these previously unseen URLs are more likely to lead to more unseen URLs than an average URL of the URLs contained in the URL pool.

At block 908, during the selection of URLs for crawling in the optimized coverage selection technique discussed above with reference to FIGS. 3-4 and Equation (1), a weighting factor may be applied to emphasize crawling of these previously unseen URLs. Consequently, these previously unseen URLs serve as bridge pages for locating additional unseen URLs 108. Additionally, in some implementations, the identified previously unseen URLs may be provided to the learning component 208 for incorporation in the techniques discussed above with reference to FIGS. 6-7.

### Example System Architecture

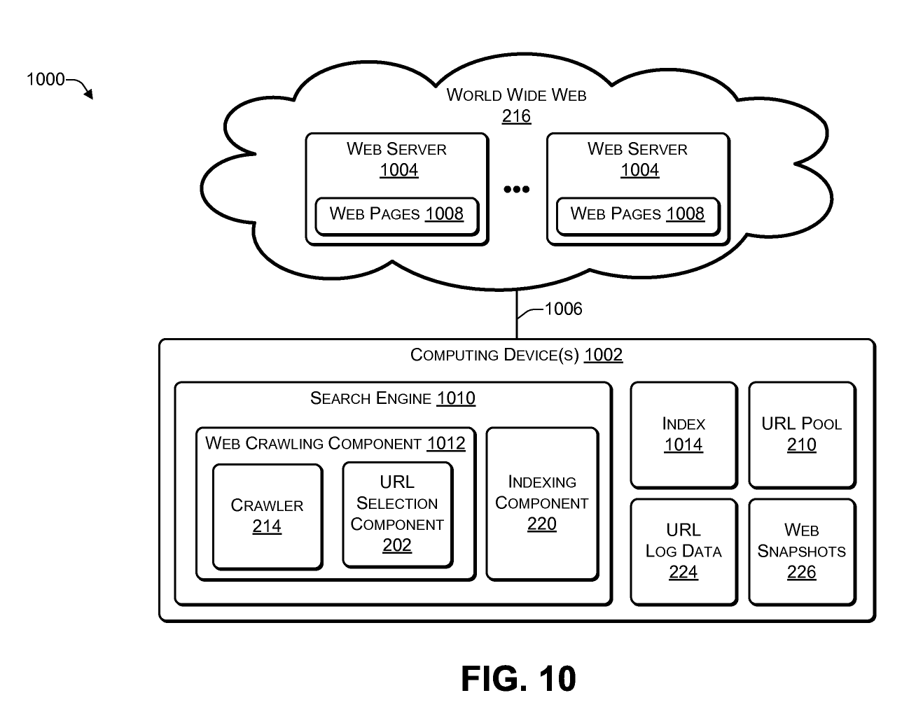

FIG. 10 is a block diagram of an example system architecture 1000 according to some implementations herein. In the illustrated example, architecture 1000 includes at least one computing device 1002 able to communicate with a plurality of web servers 1004 on the World Wide Web 216. For example, the computing device 1002 may communicate with the web servers 1004 through a network 1006, which may be the Internet and/or other suitable communication network enabling communication between computing device 1002 and web servers 1004. Each web server 1004 may host or provide one or more web pages 1008 having one or more corresponding URLs that may be targeted by a search engine 1010 on the computing device 1002. For example, search engine 1010 may include a web crawling component 1012 for collecting information from each website 1008 for generating searchable information pertaining to the web pages 1008. Web crawling component 1012 may include the URL selection component 202 and the crawler 214. Search engine 1010 may further include the indexing component 220 for generating an index 1014 based on information collected by the web crawling component 1012 from the web pages 1008. Furthermore, computing device 1002 may include additional data described above such as the URL pool 210, the URL log data 224, and the web snapshots 226.

### Example Computing Device and Environment

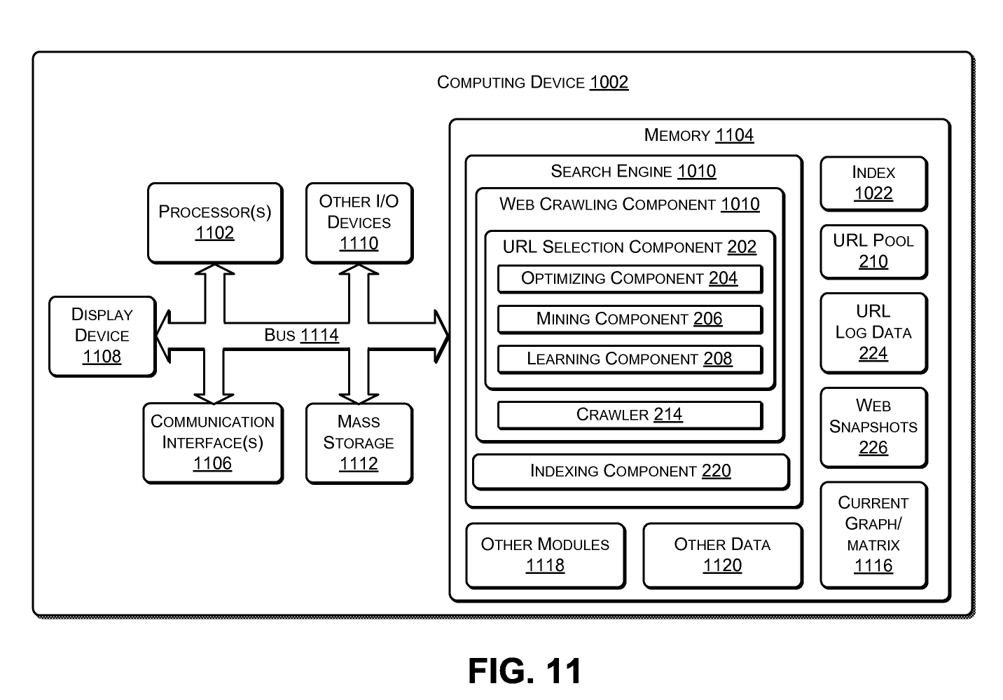

FIG. 11 illustrates an example configuration of the computing device 1002 that can be used to implement the components and functions described herein. The computing device 1002 may include at least one processor 1102, a memory 1104, communication interfaces 1106, a display device 1108, other input/output (I/O) devices 1110, and one or more mass storage devices 1112, able to communicate with each other, such as via a system bus 1114 or other suitable connection.

The processor 1102 may be a single processing unit or a number of processing units, all of which may include single or multiple computing units or multiple cores. The processor 1102 can be implemented as one or more microprocessors, microcomputers, microcontrollers, digital signal processors, central processing units, state machines, logic circuitries, and/or any devices that manipulate signals based on operational instructions. Among other capabilities, the processor 1102 can be configured to fetch and execute computer-readable instructions or processor-accessible instructions stored in the memory 1104, mass storage devices 1112, or other computer-readable storage media.

Memory 1104 and mass storage devices 1112 are examples of computer-readable storage media for storing instructions which are executed by the processor 1102 to perform the various functions described above. For example, memory 1104 may generally include both volatile memory and non-volatile memory (e.g., RAM, ROM, or the like). Further, mass storage devices 1112 may generally include hard disk drives, solid-state drives, removable media, including external and removable drives, memory cards, Flash memory, floppy disks, optical disks (e.g., CD, DVD), a storage array, a network attached storage, a storage area network, or the like. Both memory 1104 and mass storage devices 1112 may be collectively referred to as memory or computer-readable storage media herein. Memory 1104 is capable of storing computer-readable, processor-executable program instructions as computer program code that can be executed by the processor 1102 as a particular machine configured for carrying out the operations and functions described in the implementations herein.

The computing device 1002 can also include one or more communication interfaces 1106 for exchanging data with other devices, such as via a network, direct connection, or the like, as discussed above. The communication interfaces 1106 can facilitate communications within a wide variety of networks and protocol types, including wired networks (e.g., LAN, cable, etc.) and wireless networks (e.g., WLAN, cellular, satellite, etc.), the Internet and the like. Communication interfaces 1106 can also provide communication with external storage (not shown), such as in a storage array, network attached storage, storage area network, or the like.

A display device 1108, such as a monitor may be included in some implementations for displaying information to users. Other I/O devices 1110 may be devices that receive various inputs from a user and provide various outputs to the user, and can include a keyboard, a remote controller, a mouse, a printer, audio input/output devices, and so forth.

Memory 1104 may include modules and components for URL selection and web crawling according to the implementations herein. In the illustrated example, memory 1104 includes the search engine 1010 described above that affords functionality for web crawling and indexing to provide search services. For example, as discussed above, search engine 1010 may include a web crawling component 1012 having the URL selection component 202 and the crawler 214. The URL selection component may include the optimizing component 204, the mining component 206 and the learning component 208, as described above. Additionally, search engine 1010 also may include the indexing component 222 for generating the index 1022. Memory 1104 may also include other data and data structured described herein, such as the URL pool 210, URL log data 226, the web snapshots 226, and a current graph and/or adjacency matrix 1116 of the seen-and-linked URLs 110. Memory 1104 may also include one or more other modules 1118, such as an operating system, drivers, communication software, or the like. Memory 1104 may also include other data 1120, such as the crawled URL information 218, other data stored by the URL selection component 202 to carry out the functions described above, such as the records used by the learning component 208, and data used by the other modules 1118.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices. Thus, the processes, components and modules described herein may be implemented by a computer program product.

Although illustrated in FIG. 11 as being stored in memory 1104 of computing device 1002, URL selection component 202, or portions thereof, may be implemented using any form of computer-readable media that is accessible by computing device 1002. Computer-readable media may include, for example, computer storage media and communications media. Computer storage media is configured to store data on a non-transitory tangible medium, while communications media is not.

As mentioned above, computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

In contrast, communication media may embody computer readable instructions, data structures, program modules, or other data in a modulated data signal, such as a carrier wave, or other transport mechanism.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
under control of one or more processors configured with executable instructions,
receiving crawled uniform resource locator (URL) information for a plurality of crawled URLs, each crawled URL having a plurality of URL features, the crawled URL information indicating a discoverability of each URL;
applying pattern identification analysis to identify optimal values for the URL features associated with the crawled URLs having an above average level of discoverability;
identifying, for crawling, one or more uncrawled URLs having URL features corresponding to the optimal values for the URL features; and
providing the identified uncrawled URLs to a crawler for crawling.

2. The method according to claim 1, further comprising:
receiving discoverability information for the identified uncrawled URLs from the crawler following the crawling; and
performing additional pattern identification analysis to refine the optimal values for the URL features.

3. The method according to claim 1, further comprising employing the refined optimal values for the URL features to identify additional uncrawled URLs for crawling.

4. The method according to claim 1, wherein
the identified uncrawled URLs identified for crawling are provided to the crawler as a subset of a plurality of URLs selected for crawling as part of a multi-level coverage scheme;
the plurality of URLs selected for crawling also includes a selected set of URLs selected to obtain optimal coverage of crawled URLs and URLs known to be linked to the crawled URLs; and
the selected set of URLs is selected based on an adjacency matrix generated to represent links between the crawled URLs and URLs known to be linked to the crawled URLs.

5. The method according to claim 1, wherein URL features include at least one of:
URL length;
URL domain name;
URL type;
ratio of words to numbers in the URL;
special characters used in the URL; or
file type of the URL.

6. A method comprising:
under control of one or more processors configured with executable instructions,
constructing a graph from at least some linked uniform resource locators (URLs) in a URL pool;
generating an adjacency matrix corresponding to the graph;
determining, based on the adjacency matrix, a subset of URLs to provide coverage of a large number of the URLs in the graph, while performing a corresponding minimal number of URL crawls; and
providing the subset of URLs to a crawler to crawl the subset of URLs.

7. The method according to claim 6, further comprising:
receiving, from the crawler, one or more previously unseen URLs located during the crawling of the subset of URLs; and
adding the one or more previously unseen URLs to the to the URL pool.

8. The method according to claim 7, further comprising;
generating a new graph including the previously unseen URLs;
determining a new subset of URLs to be provided to the crawler based on a new adjacency matrix corresponding to the new graph.

9. The method according to claim 6, wherein the linked URLs in the URL pool comprise a first set of URLs that have already been crawled, and a second set of URLs that are known from links from the first set of URLs, but have not been crawled.

10. The method according to claim 6, further comprising
identifying, from URL log data, a particular URL that is not included in the first set of URLs or the second set of URLs;
identifying from the URL log data a preceding URL immediately preceding the particular URL in the URL log data;
assuming a link between the particular URL and the preceding URL; and
adding the particular URL to the URL pool as one of the linked URLs based on the assumed link.

11. The method according to claim 6, further comprising:
selecting at least one uncrawled URLs from the URL pool based on a probability of the selected uncrawled URL having a higher level of discoverability of unseen URLs compared to other URLs in the URL pool; and
providing the at least one uncrawled URL to the crawler to locate unseen URLs.

12. The method according to claim 11, wherein the probability is determined based on learned values of one or more URL features indicative of higher levels of discoverability.

13. The method according to claim 12, wherein the learned values of the one or more URL features are learned based on statistical analysis of the URL features in relation to discoverability of a plurality of URLs previously submitted to the crawler.

14. The method according to claim 6, further comprising:
comparing the graph with an earlier graph generated at an earlier point in time to identify at least one URL contained in the graph that was not contained in the earlier graph; and
applying a weighting factor to the at least one URL to cause the at least one URL to have a high probability to be selected for crawling to locate unseen URLs.

15. Computer-readable storage media containing the executable instructions to be executed by the one or more processors for carrying out the method according to claim 6.

16. A computing device comprising:
a processor in communication with storage media;
a URL pool containing a plurality of URLs as candidates for crawling selection;
a URL selection component, maintained on the storage media and executed on the processor, to select a subset of URLs from the URL pool for submission to a crawler;
a mining component executed on the processor to identify a previously unseen URL based on a comparison of URLs known at a first point in time with URLs known at a second point in time; and
an optimizing component executed on the processor to provide a greater weight to the previously unseen URL than to other URLs in the URL pool during selection of the subset of URLs for submission to the crawler.

17. The computing device according to claim 16, wherein the optimizing component is executed to:
construct a graph from at least some linked URLs in the URL pool;
generate an adjacency matrix corresponding to the graph;
determine, based on the adjacency matrix, a plurality of URLs for submission to the crawler.

18. The computing device according to claim 17, wherein the adjacency matrix is used to identify a subset of URLs having the greatest number of links to other URLs as the plurality of URLs for submission to the crawler.

19. The computing device according to claim 16, wherein the mining component is executed to detect, from URL log data, a one or more URLs that are not included in the URL pool.

20. The computing device according to claim 19, wherein for each particular URL detected, the mining component is executed to:
identify from the URL log data a preceding URL immediately preceding the particular URL in the URL log data;
assume a link between the particular URL and the preceding URL; and
add the particular URL to the URL pool based on the assumed link.
